(19) United States
(12) Patent Application Publication
(10) Pub. No.: US 2006/0150258 A1
(43) Pub. Date: Jul. 6, 2006

(54) Proprietary component for use in an open-platform device and corresponding method

(76) Inventors: Jimmy Z. Lee, Miramar, FL (US); Jyh-Han Lin, Parkland, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/026,934

(22) Filed: Dec. 30, 2004

(51) Int. Cl. G06F 11/00; G06F 1/26; G08B 13/00; G08B 21/00; G08B 29/00; G06F 12/14; H04L 9/32; G06F 11/30

(52) U.S. Cl. 726/34; 713/193

(57) ABSTRACT

A proprietary component (300) receives (101) substantially unique open-platform device information and stores (102) it. The proprietary component, upon later detecting (103) requested usage of its capabilities, receives (105) verification information (from, for example, the open-platform device) and compares (106) that verification information against the previously stored information. If this comparison does not provide an expected result (107), the proprietary component prohibits (109) some or all of its capabilities and functionality. Such prohibition can be temporary or permanent. Such prohibition can also be conditioned, if desired, upon similar tests being conducted with respect to other proprietary components as may also have been operably engaged with the open-platform device.

### TECHNICAL FIELD

This invention relates generally to proprietary components and more particularly to facilitating control over the use of a proprietary component in an open-platform device.

### BACKGROUND

Various open-platform devices are known in the art. Such devices typically operate using an operating system (such as a Windows family operating system) that will, in turn, permit compatible support of a variety of proprietary components (wherein the proprietary components can be hardware-based, software-based (including but not limited to software components in the form of a dynamic link library, a static library, or an executable application, to name a few), or a combination thereof). As used herein, “proprietary” will be understood to refer to some degree of legal and/or technical control wherein at least some aspect of the corresponding component (such as the location, point of installation, manner of use, quantity of use, or the like) is subject to such control.

To illustrate, a given cellular telephone may comprise a microprocessor that operates a given operating system which accepts and supports the operation of proprietary components such as proprietary third party media engines (or even engagement with a supplemental microprocessor). So configured, such a media engine can be installed in (or engaged with) the microprocessor and the cellular telephone will thereafter have access to the use of that media engine during its operations.

Unless some practical degree of control can be established with respect to the installation and/or use of that media engine component, however, the proprietary nature of that component may be effectively lost. For example, the intent of the third party who invests the resources to develop, market, and support that media engine component may be effectively foiled if that one copy can be installed on a succession of open-platform devices beyond an initial expected and authorized installation.

### BRIEF DESCRIPTION OF THE DRAWINGS

The above needs are at least partially met through provision of the proprietary component for use in an open-platform device and corresponding method described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a proprietary component as is installed in an open-platform device will receive from that open-platform device at least one item of information that is substantially unique to that open-platform device and will store that information. Upon then detecting requested usage of the proprietary component, the proprietary component obtains verification information (typically from the open-platform device itself) and compares that verification information against the previously stored information. When a match occurs, the proprietary component can facilitate the requested use. When the comparison fails to correspond to an expected result, however, at least some usage (and possibly all usage) of the proprietary component can be prohibited.

Depending upon the embodiment, the verification information can be automatically provided by the open-platform device or can be provided in response to a specific inquiry from the proprietary component. Depending upon the needs of a given setting, the above-described prohibition can be temporary or can be essentially permanent.

Pursuant to one approach, the proprietary component can also receive (and/or exchange) similar kinds of verification information with other proprietary components as may also have been installed in the open-platform device. In such a case, requested usage of the proprietary component can be further conditioned upon similarly verifying the presence of such additional proprietary components through comparison of later-received verification information with previously stored identifying information.

So configured, the proprietary component, once installed, will prohibit at least some degree of operability should it be removed and reinstalled on another open-platform device. These teachings are useful with software-only components but are particularly useful when deployed in conjunction with components that are at least partially hardware-based (such as architectures that make use of two or more processors, where one processor is an open-platform device and at least one of the additional processors comprises a proprietary component that interacts with the open-platform processor). This, in turn, permits the provider of the proprietary component to retain at least some degree of control with respect to the applied usage of a given proprietary component. Those skilled in the art will appreciate that such teachings can be effected in a relatively transparent manner and with little or no interaction required on the part of an end-user.

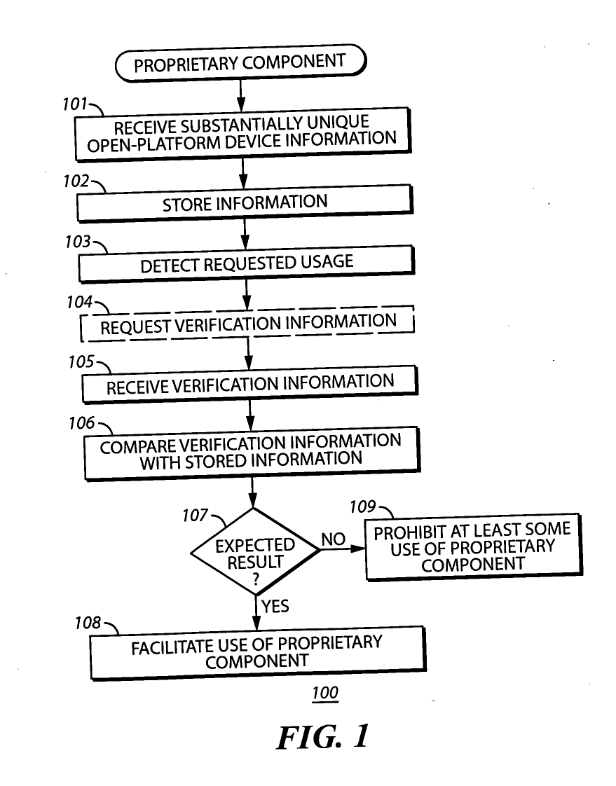

These and other benefits may become clearer upon making a thorough review and study of the following detailed description. Referring now to the drawings, and in particular to FIG. 1, a corresponding process 100 suitable for use by a proprietary component that has been installed in an open-platform device will preferably comprise receiving 101 from that open-platform device at least one item of information that is substantially unique to that open-platform device and storing 102 information as corresponds to that received information to provide stored information.

This unique information can assume any of a wide variety of forms, including but not limited to a unique (or substantially unique) hardware identifier as may correspond in some predetermined way to the open-platform device. Such a hardware identifier might comprise, for example, a platform serial number as was assigned during manufacture of the device, or another unique identifier as may have been assigned by the manufacturer, a third party (such as a distributor or system operator), a standards body, a law enforcement agency, or the like.

As another example, the unique identifier can comprise, for example, a random sequence number as may have been developed, obtained, or otherwise provided to the open-platform device. Such a random sequence number can be developed in any of a wide variety of known ways. Furthermore, such a random sequence number could be uniquely generated for each proprietary component that a given open-platform device might encounter on an as-needed basis such that each such proprietary component would be provided with a different unique identifier by the open-platform device. In the alternative, if desired, a single random sequence number could be generated by the open-platform device (or otherwise provided thereto) and used with all proprietary components as might become associated with the open-platform device.

Such examples are to be understood as being illustrative of a unique identifier and are not to be taken as an exhaustive listing. Instead, it will be well appreciated that these teachings are compatible for use with any of a wide variety of presently known (as well, in all probability, with various hereafter-developed) unique identifiers as may be available and/or preferred in a given application setting.

This receipt 101 of unique information can be the result of any of a variety of instigating conditions. For example, such information may be automatically initially provided upon first installing the proprietary component. As another example, such information may be provided by the open-platform device only in response to a specific request tendered by the proprietary component for such information. Other possibilities also no doubt exist and it will be understood that these teachings are not limited in this regard.

When the proprietary component then subsequently detects 13 requested usage of the proprietary component (by, for example, the open-platform device itself and/or another proprietary component), the proprietary component can then optionally request 104 verification information and then, regardless, receive 105 verification information (in this case, preferably from the open-platform device that seeks to make use of the proprietary component). In a case where the proprietary component does not itself request such verification information, it may be desirable to have the open-platform device (or a suitable proxy) automatically provide such information concurrent with or at least in association with the taking of an action that will likely be interpreted by the proprietary component as a request for usage of the proprietary component.

Upon receiving such verification information, the proprietary component can then compare 106 that verification information with respect to the stored information referred to earlier. The proprietary component can then determine 107 whether that comparison corresponds to an expected result (for example, whether the verification information matches previously supplied identification information for the open-platform device). When true, this process 100 can then effect facilitation 108 of the requested use of the proprietary component. When false, however, this process 100 can prohibit 109 at least some usage of the proprietary component.

This prohibition of usage can be partial or complete. When partial, the prohibition can be with respect to certain features or capabilities of the proprietary component and/or with respect to a permitted duration of usage. This prohibition can also be either temporary or permanent. When temporary, and depending upon the needs of a given setting, the prohibition may persist for only some predetermined period of time or may require intervention on the part of an authorized person (for example, an authorized technician who can effectively cause the proprietary component to reset itself and/or to other permit present usage via entry of an appropriate authorization code or the like).

So configured, those skilled in the art will recognize that such a proprietary component will likely not operate to full capacity when removed from a first installed setting and then re-installed in a new and different setting, as the verification information provided by the second open-platform device will not likely match the unique identifying information provided by the initial open-platform device. This, in turn, can greatly support controlling the subsequent distribution and use of the proprietary component itself.

In the embodiment described above, the proprietary component interacts with the open-platform device itself to establish its proper operating environment and to thereafter determine, at least from time to time, whether the proprietary component continues to remain within an authorized operational setting. As mentioned earlier, however, a given open-platform device, by its very nature, may also couple, now or in the future, to other proprietary components. These teachings are employable to further leverage such circumstances.

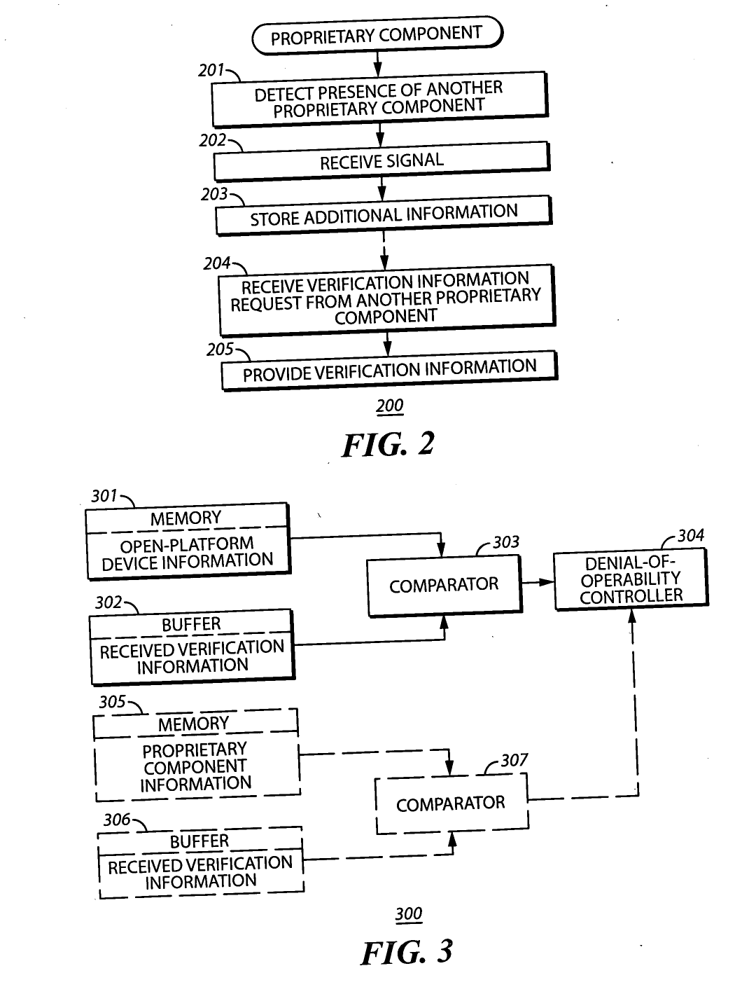

In particular, and referring now to FIG. 2, a given proprietary component, upon detecting 201 the presence of at least one other proprietary component, can receive 202 a signal from that at least one other proprietary component and store 203 information as corresponds to that received signal. In a preferred approach, this signal again comprises a unique identifier as corresponds to the other proprietary component (wherein, again, “unique” shall be understood to encompass both literally unique identifiers and practically or essentially unique identifiers). The transmission of this signal can be prompted by any of a variety of circumstances, including but not limited an automated periodic beacon-style transmission, an automated transmission that occurs in response to detecting initial installation of the proprietary component (or some other operational event of interest or relevance), a transmission provided in response to a specific inquiry from a newly installed proprietary component, and so forth.

So configured, and referring again to FIG. 1, when the proprietary component subsequently requests 104 verification information, this request can be directed both to the open-platform device and also to other such proprietary components as may be present. Those skilled in the art will understand and appreciate that such a request can comprise a universal request that is received and understood by all such element or can comprise a plurality of individual messages intended for discrete specific target elements. The proprietary component can then receive 105 verification information from both the open-platform device and such other proprietary components as may be present and compare 106 that received verification information against the previously received information as was described above. Subsequent use, or prohibition of use, can then be predicated upon determining whether each such item of verification information matches in an expected way with the previously received and stored information.

So configured, the operational security offered a given proprietary component is further enhanced. In particular, the greater the number of additional proprietary components as may be operably engaged with a given open-platform device, effectively the greater the protection offered by these teachings. In particular, when each such proprietary component interacts with every other proprietary component in this manner, removal of any of the proprietary components will not only render the removed proprietary component operationally limited but will also render the remaining proprietary components similarly limited as well.

To more fully participate in such a distributed fashion, and referring again to FIG. 2, the proprietary component, upon receiving 204 a request for verification information as corresponds to the proprietary component from another proprietary component as also interacts with the open-platform device can then itself provide 205 that verification information to the other proprietary component. This, in turn, permits the other proprietary component to condition its own future operability, at least in part, upon a future comparison of the verification information as may be subsequently provided by the proprietary component to this presently provided information.

These teachings can be enabled in various ways. Pursuant to a not-untypical approach, and referring now to FIG. 3, a given illustrative example of a proprietary component 300 will comprise a memory 301 that serves to store at least one item of information that is substantially unique to a particular open-platform device. This can be, for example, identifying information as is initially received by the proprietary component upon initial installation as suggested above. This proprietary component 300 also comprises a buffer 302 that serves, in a preferred approach, to store verification information as is received from an open-platform device (and/or other proprietary components as are suggested above). This memory 301 and buffer 302 then operably couples to the inputs of a comparator 303 that serves, for example, to compare the information stored in the memory 301 with subsequently received verification signal information as is stored in the buffer and to provide an output that corresponds to that comparison. The output of the comparator 303 then operably couples to a trigger input of a denial-of-operability controller 304.

The latter responds to the comparison output of the comparator 303 to effect the above-described teachings. In particular, this controller 304 serves to render the proprietary component 300 at least partially inoperable when the proprietary component is used with an open-platform device other than a particular open-platform device.

As described above, it is also possible to so condition the operability of the proprietary component 300 based upon the presence of other proprietary components. To support such an approach, the proprietary component 300 can also optionally comprise a memory 305 that serves to store identifying information as corresponds to such other proprietary component ( or components), a buffer 306 to store verification information as corresponds to such other proprietary component(s), and a comparator 307 that operably couples to such memory 305 and buffer 306 in order to compare their respective contents and provide a comparison result to a trigger input of the denial-of-operability controller 304. So configured, the proprietary component 300 can be rendered at least partially inoperable when used in conjunction with an open-platform device that presently lacks one or more other proprietary components that this proprietary component otherwise expects to be present.

Those skilled in the art will recognize that the described embodiment can be configured and realized in various ways. For example, a single memory platform can serve as the various memories and buffers depicted in FIG. 3. Similarly, a single platform (such as a properly programmed microprocessor) can serve as one or both of the comparators as well as the denial-of-operability controller. It will also be understood that such a proprietary component will likely include other components and elements to support other desired capability and functionality. As these teachings are compatible with a wide variety of such possible arrangements, and further since these teachings are not particularly sensitive to selection or use of any one particular architectural arrangement or set of other capabilities, for the sake of brevity and the preservation of narrative focus such details are not presented here.

So configured, it will be appreciated that these teachings yield a proprietary component having an ability to store both information that tends to uniquely correspond to a particular open-platform device and other information that tends to uniquely correspond to at least one other proprietary component as also interacts with that particular open-platform device. Such a proprietary component then has the ability to condition its own subsequent operability upon receipt of subsequent information from both the particular open-platform device and the at least one other proprietary component, which subsequent information corresponds (or not) in an expected way with the stored information. This can include, as desired, the ability to request, on a repeated basis, such subsequent information and to compare, on a repeated basis, this subsequent information against the stored information.

These teachings are deployable in various settings. As noted above, for example, these approaches will work well in a dual-processor environment. These teachings can also be used, however, as between a proprietary component and a remotely located server and/or application to achieve the same benefits.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, upon determining that later supplied verification information from an open-platform device does not yield the expected match, the proprietary component, prior to effecting its own disablement, can first take steps to partially or fully disable other proprietary components as may also be operably engaged with the present open-platform device. This approach would aid in providing protection for proprietary components that otherwise lack a native ability to implement these teachings or that are not presently being otherwise tasked by the open-platform device. As another example, such a proprietary component could also be provided with an ability to provide an alert via an available communication bearer to a predetermined server regarding invocation of operability prohibitions as per these teachings. Such an alert could be coupled with such other useful information as may be available to the proprietary component, including but not limited to geographic location information, current identifying and/or addressing information for the open-platform device, and so forth.

We claim:

1. A method for use by a proprietary component as installed in an open-platform device comprising:
receiving from the open-platform device at least one item of information that is substantially unique to that open-platform device;
storing information as corresponds to the at least one item of information to provide stored information;
detecting requested usage of the proprietary component;
in response to detecting the requested usage of the proprietary component, receiving verification information;
comparing the verification information with respect to the stored information to provide a comparison result;
when the comparison result corresponds to an expected result, facilitating use of the proprietary component;
when the comparison result does not correspond to the expected result, prohibiting at least some usage of the proprietary component.

2. The method of claim 1 wherein receiving from the open-platform device at least one item of information that is substantially unique to that open-platform device further comprises receiving from the open-platform device an item of information that corresponds, at least in part, to a hardware identifier as corresponds to the open-platform device.

3. The method of claim 2 wherein receiving from the open-platform device at least one item of information that is substantially unique to that open-platform device further comprises receiving from the open-platform device the item of information which further corresponds, at least in part, to a random sequence number.

4. The method of claim 1 wherein receiving verification information further comprises receiving verification information in response to a request for the verification information.

5. The method of claim 4 wherein receiving verification information further comprises receiving the verification information from an open-platform device that seeks to make use of the proprietary component.

6. The method of claim 1 wherein the proprietary component comprises, at least in substantial part, a software program.

7. The method of claim 1 wherein, when the comparison result does not correspond to the expected result, prohibiting at least some-usage of the proprietary component further comprises permanently prohibiting the at least some usage of the proprietary component.

8. The method of claim 1 wherein, when the comparison result does not correspond to the expected result, prohibiting at least some usage of the proprietary component further comprises prohibiting all usage of the proprietary component.

9. The method of claim 1 and further comprising:
detecting a presence of at least one other proprietary component;
receiving a signal from the at least one other proprietary component;
storing information as corresponds to the signal to provide additional stored information;
in response to detecting the requested usage of the proprietary component, also receiving additional verification information from the at least one other proprietary component;
comparing the additional verification information with respect to the additional stored information to provide an additional comparison result.

10. The method of claim 9 and further comprising:
when the additional comparison result corresponds to a second expected result, facilitating use of the proprietary component;
when the additional comparison result does not correspond to the second expected result, prohibiting at least some usage of the proprietary component.

11. The method of claim 1 and further comprising:
receiving a request for verification information as corresponds to the proprietary component from another proprietary component as also interacts with the open-platform device;
providing the verification information as corresponds to the proprietary component to the another proprietary component;
such that future operability of the another proprietary component can be conditioned, at least in part, upon a future comparison of the verification information as corresponds to the proprietary component to a subsequently received verification signal.

12. A proprietary component, comprising:
a memory having at least one item of information that is substantially unique to a particular open-platform device stored therein;
a buffer;
a comparator having inputs operably coupled to the memory and the buffer;
a denial-of-operability controller having a trigger input that is responsive to the output of the comparator;
such that the proprietary component will be at least partially inoperable when used in conjunction with an open-platform device other than the particular open-platform device.

13. The proprietary component of claim 12 wherein the buffer has stored therein verification information as was received from the particular open-platform device.

14. The proprietary component of claim 13 wherein the buffer has stored therein verification information as was received from the particular open-platform device in response to detection of a proprietary component actuation process.

15. The proprietary component of claim 12 wherein the comparator comprises means for comparing the at least one item of information that is substantially unique to a particular open-platform device with a subsequently received verification signal that is stored in the buffer.

16. The proprietary component of claim 12 and further comprising:
a second memory having at least one item of information as was received from another proprietary component as also interacts with the particular open-platform device stored therein;
a second buffer;
a second comparator having inputs operably coupled to the second memory and the second buffer;
and wherein the denial-of-operability controller also has a trigger input that is responsive to the output of the second comparator;
such that the proprietary component will be at least partially inoperable when used in the absence of the another proprietary component.

17. A proprietary component comprising:
means for storing:
first information that tends to uniquely correspond to a particular open-platform device;
second information that tends to uniquely correspond to at least one other proprietary component as also interacts with the particular open-platform device;
means for conditioning subsequent operability of the proprietary component upon receipt of subsequent information from both the particular open-platform device and the at least one other proprietary component, which subsequent information corresponds in an expected way with the first and second information.

18. The proprietary component of claim 17 wherein the means for conditioning further comprises means for requesting, on a repeated basis, the subsequent information and for comparing, on a repeated basis, the subsequent information against the first and second information.
